(19) United States
(12) Patent Application Publication
(10) Pub. No.: US 2005/0068630 A1
(43) Pub. Date: Mar. 31, 2005

(54) Sun protection device

(76) Inventors: Peter Nitz, Gundelfingen (DE); Christopher Buhler, Freiburg (DE); Andreas Gombert, Freiburg (DE); Benedikt Blasi, Freiburg (DE)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/498,883

(22) PCT Filed: Dec. 4, 2002
(86) PCT No.: PCT/EP02/13738

(30) Foreign Application Priority Data
Dec. 17, 2001 (DE) 101 61 938.3

(51) Int. Cl. G02B 27/00

(52) U.S. Cl. 359/613; 359/601

(57) ABSTRACT

Disclosed is a sun protection device for transparent apertures in a building against direct incident sunlight entering the interior of the building, said device comprising at least one optical flat element (F) consisting of an at least partially transparent material, being installable in the region of said building aperture, and having two flat element sides facing each other, of which one (E) is designed non-structured and plane, and the other (S) being provided with prismatic linearly extending structural elements (SE) running in parallel and recurring periodically in lateral direction. The invention is distinguished in that the structured flat element side (S) is provided, facing the unstructured plane, designed flat element side (E), with an at least largely coparallel surface (O), over which the structural elements (SE) project, that the structured elements (SE) have a triangular cross section area having a lateral edge (C), which coincides with the surface (O), as well as two lateral flanks (A,B) protruding above the surface, with a defining surface (A*) being assigned to the lateral flank (A) and a defining surface (B*) being assigned to the lateral flank (B), that the at least two adjacent structural elements are laterally separated by a flat section (D) of the surface (O), and that the lateral flank (A) forms an angle 90°-α with the surface, an angle α+β with the lateral flank (B) and the lateral flank (B) forms an angle 90°-β with the surface.

### TECHNICAL BACKGROUND

The present invention relates to a sun protection device for transparent apertures in buildings against direct incident sunlight entering the interior of the building. The sun protection comprises at least one flat optical element consisting of an at least partially transparent material, is installable in the region of the building aperture, and has two flat element sides facing each other, of which one is designed non-structured and plane, and the other is provided with prismatic linearly extending structural elements running in parallel and recurring periodically in lateral direction.

### PRIOR ART

Glazed surfaces are being increasingly employed in modern architecture. Fundamentally, this element of architectonic design has much to recommend it, on the one hand, because solar radiation/solar energy transmitted through the windows can effectively contribute to covering thermal energy needs during the heating period and, on the other hand, because light conditions are noticeably improved by daylight enhancing illumination.

Windows and sunlight-transmitting glazing can, however, also have undesirable effects. For example, intensive, direct incident sunlight can be glaring in the interior of rooms, in particular, at computer screen workplaces. Furthermore, on warm summer days, too great solar energy input can lead to uncomfortably high room temperatures.

Today, in particular, in commercial construction (administration and office buildings, . . . ), the energy primarily needed for cooling in summer often exceeds the energy needed for heating in the winter. Thus, there is a justified desire to avoid undesired solar energy input as far as possible in summer and, if there are computer screen workplaces located in the glazed room, to avoid glare.

In addition to the classical approaches, such as placing awnings or balconies before the window surfaces, mechanical shading, respectively sun protection systems with moveable parts, such as venetian blinds and sheer curtains, as well as technically complicated switchable optical layers—all these solutions have various drawbacks such as inflexible illumination of the interior of the room, too high costs or technically unsolvable for large window surfaces—light-guiding optical elements operating on the basis of optical refraction, reflection and/or interior total reflection are known and, thus, are elements for sun protection and glare protection and contribute to improving exploitation of daylight.

Such type optical elements are usually designed as transparent flat elements and are provided with prismatically designed structures on at least one of their surfaces. Depending on the angle of incidence, these structures transmit, deflect, scatter or reflect the incident light. If such type surface elements are installed in a stationary manner, as a result of the seasonally varying position of the sun, the direct sunlight is selectively reflected in certain periods, e.g. during the summer months. Whereas during the rest of the year, it can pass the light deflection system almost unhindered.

The applications of the light-deflecting prisms can be broadened in that the structured areas are installed in such a moveable manner that the alignment of the structure in relation to the light source can be selectively varied. DE 1 497 348, DE 31 38 262 A1, U.S. Pat. No. 4,773,733, DE 195 42 832 A1 or DE 197 00 111 A1 describe such systems in which structured lamellas or prism rods are borne in a rotatable manner about an essentially horizontal axis, due to which the light-guiding structures align selectively or guide according to the sun. However, the drawbacks associated with classical venetian blinds and sheer curtains regarding high purchase costs and susceptibility to mechanical failure also apply to these moveable systems.

In other systems, the light-guiding structure, respectively the optically effective structure, is applied in a flat stationary manner on a transparent pane, board or glazing. The structure that influences the path of the light can lie either on the side facing the light source (“exterior”) or on the side facing away from the light source (“interior”) of a transparent or translucent board or glazing. DE 831 449 or FR 2 463 254 describe such type systems with externally located reflecting, prismatic structures which fulfill the desired functions. Internally located prismatic systems are described in, e.g, DE 113 391, U.S. Pat. No. 2,812,691, U.S. Pat. No. 4,519,675, DE 35 17 610 A1, DE 195 38 651 A1 or DE 198 34 050 A1. Moreover, systems with structures on the interior as well as on the exterior are described in for example DE 1 50 365.

DE 26 15 379 A1, DE 32 27 118 C2 and U.S. Pat. No. 4,498,455 describe light-guiding systems in which the effect of a light-guiding prism system, respectively a prismatically arranged lamella system, is further improved in that one or a multiplicity of flanks of the respective prism structure, respectively the lamellas, are provided with a highly reflecting, absorbing or strongly scattering coating, thus for example are metal coated. Only the rotatably borne lamella systems, such as lamellas, prism rods, allow in certain positions partial direct vision through the glazing system between two adjacent lamellas/rods.

However, all the mentioned flatly installed systems have the drawback that, due to the structuring, direct vision through the flat systems is impossible. Flatly installed systems can, therefore, not be employed in façade areas in which direct visions is desired or even an absolute necessity.

Another system in which partial optical direct vision is given is composed of complementary structures which utilize that, when passing a thin, plane-parallel split, the beam is only minimally offset in parallel. Thus an element that fulfills a sun protection function due to total reflection at certain angles of incidence can be provided with direct visions properties in that a complementary structure is added to the element. Such type systems are known, for example, from DE 17 40 553, DE 11 71 370, U.S. Pat. No. 2,976,759, U.S. Pat. No. 3,393,034, U.S. Pat. No. 4,148,563, U.S. Pat. No. 4,519,675, U.S. Pat. No. 5,880,886, DE 195 42 832 A1 and DE 196 22 670. However, those complementary structures, which are designed with slanted triangular prisms as the basic structure, have the disadvantage that there are no joining surfaces to which the structure and complementary structure could be tacked together respectively glued together. In the prior art structures, whose basic structure is always designed “rectangular”, as described in DE 17 40 553 and DE 196 22 670, the fronts can be utilized as gluing surfaces. DE 196 22 670, in particular, describes one possibility, respectively one method, how structure and complementary structure can be joined and connected.

Only U.S. Pat. No. 5,880,886 (Milner, 1994) describes assembled structures and complementary structures having a partial direct vision that are suited for flat application, i.a., in vertical glazing. Compared to a triangular prism in the assembled structures, the tip of the prism is “replaced” by a part of the surface, which is essentially aligned plane-parallel to the continuous “rear side” plane surface and allows partial direct vision. The direct vision region, respectively the part of the surface which allows in principle partial direct vision, is located at any rate on the “protruding side” of the structure. In contrast to this, the complementary structures mentioned in U.S. Pat. No. 5,880,886 do not possess any direct vision areas, but rather (partial) direct vision is solely achieved by the complementary property of the two utilized structures.

Due to their two-component design, the prior complementary structures with optical direct vision properties are complicated and consequently expensive to produce. Moreover, they all have light deflecting properties which are only able to deflect the incident sunlight into the interior of the room, preferably toward the ceiling area. There is no deviation to the outside, respectively by reflection to the outside does not occur or only to a limited extent.

### DESCRIPTION OF THE INVENTION

The object of the present invention is to provide a sun protection device for transparent apertures in buildings against direct incident sunlight entering the interior of the building in a manner that ensures effective sun protection and at the same time possesses optical direct vision properties. The geometry and construction of the sun protection device should be as simple as possible in order to keep production costs low. Furthermore, the sun protection should contribute decisively to reducing incident light entering the interior of the building, in particular when the sun stands high, as occurs during the warm seasons.

The solution to the object of the present invention is set forth in claim 1. Advantageous features that further develop the inventive idea are the subject matter of the subclaims and the entire description, in particular, with reference to the preferred embodiments.

A key element of the present invention is that a sun protection device for transparent apertures in buildings against direct incident sunlight entering the interior of the building, comprising at least one optical flat element consisting of at least partially transparent material, is installable in the region of the building aperture, and has two flat element sides facing each other, of which one is designed non-structured and plane, and the other is provided with prismatic linearly extending structural elements running in parallel and recurring periodically in lateral direction, is designed in such a manner that the structured flat element side facing the non-structured, plane designed flat element side is provided with an at least largely coparallel surface, over which the individual structural elements project. The individual structural elements each have a triangular cross-section surface enclosed by a lateral edge, which coincides with the surface, and by two lateral flanks protruding above the surface. The individual structural elements, thus, represent three-dimensional prismatic bodies which are defined by the two unoccupied defining surfaces, which each are associated to the two lateral flanks protruding above the surface. In order to ensure the optical direct vision properties through the invented flat element, at least two adjacent structural elements are disposed separated laterally from each other by a flat section of the surface. By means of each of these flat sections, a practically unimpeded direct vision is ensured through the optical flat element consisting of transparent material. Moreover, one of the two lateral flanks and the surface form a 90°-α angle. Furthermore, the two lateral flanks form together an a +β angle and finally the other lateral flank and the surface form a 90°-β angle. In any event, a is not equal to β so that it is ensured that one lateral flank is always longer than the other. However, for reasons of effective light deflection it is particularly advantageous if the longer lateral flank is always disposed facing the incident sunlight.

The sun protection device designed according to the present invention, for which the terms light-deflection device or antiglare device are equally applicable, is based on creating optically effective surface structuring on an optical flat element consisting of a transparent material. The periodically recurring structural elements disposed on one surface of the flat element are separated in such a manner that in the event of oblique illumination, none of the single structural elements shades an adjacent structural element. Notably, if the structural elements were lined up in a row directly adjacent to each other, the shadows of the single structural elements would fall on the respective adjacent structural element, due to which the optical effect of the structural element would be lost at least in the shaded area. However, if the single structural elements are separated in such a manner that no, respectively only negligible, shading occurs between the single adjacent structural elements and, in addition, if the flat section which the spacing of the two directly adjacent structural elements rendered unoccupied remains unstructured and preferably remains plane, an optical situation of two exactly plane-parallel or practically plane-parallel panels is yielded in these flat sections—looking at the respective flat section and the, flat anyway, rear side of the flat element—thereby permitting unimpeded, in particular image-retaining direct vision.

Even in the embodiment variants of the invented sun protection device, in which the respective flat sections mutually laterally separating the two structural elements form a small angle with the plane rear side of the flat elements, the optical direct vision properties are still retained although the direct vision image is imaged slightly offset, which in some circumstances is tolerable and in some cases even desired.

Advantageously, the flat element is installed with its structured flat element side in the region of the building aperture in such a manner that the structured side of the flat element faces the incident sunlight. As will be shown in more detail, the flat element designed according to the present invention, however, is able to develop a desired antiglare effect, respectively protective effect, in inverse installation form, i.e. the structured side of the flat element faces the interior of the building.

Even if the main interest and field of application of such flat elements is the integration of the sun protection effect designed according to the present invention in vertically oriented building apertures, respectively by integrating the sun protection device in vertical window surfaces, their use in tilted building apertures, such as for example in roof areas or slanted façade flanks is fundamentally also possible and feasible.

The exact geometric design and arrangement of the lateral flanks, respectively the defining surfaces of the single structural elements depends fundamentally on the type and purpose of their use, i.e. depending on whether the flat elements are arranged in a vertical or oblique manner or whether the structured side of the flat element faces toward or away from the incident sunlight. Particular attention should be paid to the local lighting conditions given by the latitude as well as by the season-dependent orbit of the sun, respectively the angle of the position of the sun.

In view of the preceding individually to be considered conditions, the lateral flanks, respectively the defining surfaces of the single structural elements should preferably be oriented slanted toward each other and toward the incident sunlight in such a manner that the sunlight impinging on the individual structural elements from a certain angle is almost completely masked out, i.e. deflected to the outside by way of internal total reflection, respectively reflected into an external region facing away from the interior of the building. However, if the sunlight impinges on the corresponding structural elements from the other angles, the sunlight is guided or deflected into the interior. Consequently, the sun protection device according to the invented design, in which the structured side S faces the light source, is distinguished in its transmission properties by a characteristic disruption of the hemispherical optical transmission of direct incident sunlight on the structural elements. A detailed description is given, by way of example, in the following with reference to the drawings.

### BRIEF DESCRIPTION OF THE DRAWINGS

The present invention is made more apparent, by way of example in the following without the intention of limiting the scope or spirit of the overall inventive idea using preferred embodiments with reference to the accompanying drawings.

FIGS. 1a,b show schematic sectional drawings to explain the structural elements designed according to the present invention (1a: prior art),

FIG. 2 shows the lighting situation, in which the structured side of the flat elements faces the interior of the building to explain the invented function,

FIG. 3 shows a cross section of a sun protection device designed according to the present invention,

FIG. 4 shows a typical course (qualitatively) of radiation inside the sun protection device during masking out,

FIG. 5 shows a transmission diagram for the lighting situations depicted qualitatively in FIG. 4,

FIG. 6 shows a cross section of a sun protection device having curved surfaces and rounded edge courses,

FIGS. 7,8 show sun protection devices in a complementary arrangement, and

FIGS. 9-11 show diagrams of the transmission of various preferred embodiments.

### WAYS TO CARRY OUT THE INVENTION, COMMERCIAL APPLICABILITY

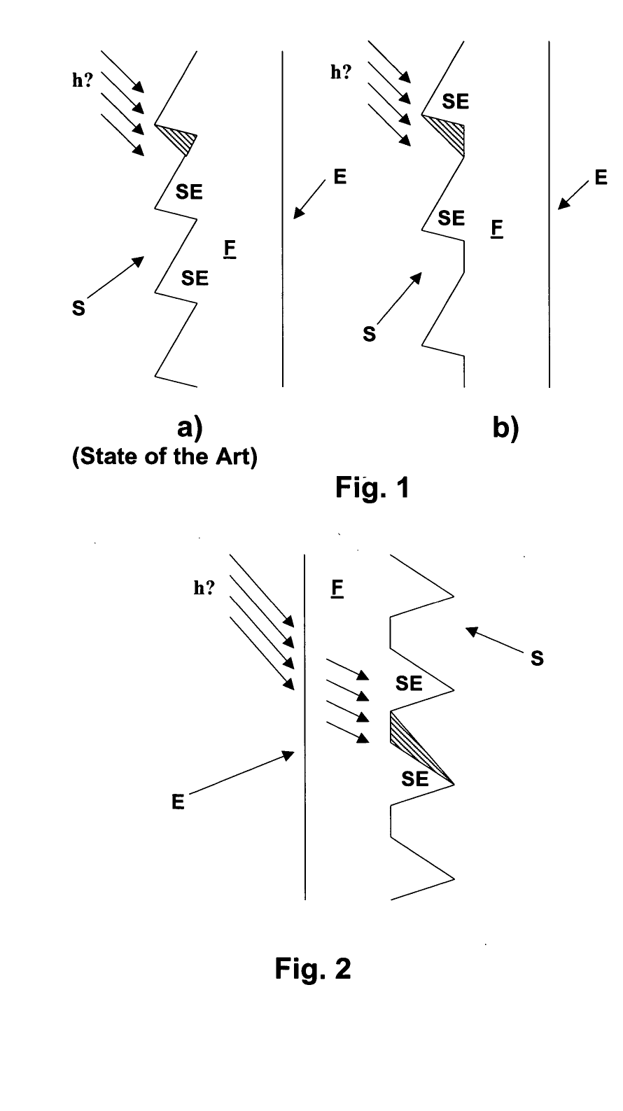

FIG. 1a shows the prior art situation in which a one-sided structured flat element F is irradiated by sunlight hν. The single structural elements SE bordering each other directly adjacent in a sawtooth-structured manner yield, in oblique radiation, to mutual self-shading (see hatching). However, in regions where self-shadowing occurs, the single structural elements lose their optical effect. In contrast to this, FIG. 1b shows an invented flat element F designed in such a manner that in the regions where mutual shading as in FIG 1a would occur, two adjacent structural elements SE are laterally separated by a flat section D. The flat sections are disposed preferably coparallel to the otherwise plane-designed flat element side E. It is in these flat element sections D, which are oriented coparallel to the flat element side E, that optical direct vision conditions prevail so that a flat element F designed according to the cross section of FIG. 1b fabricated of a transparent material can be integrated for sun protection purposes in the façade region of the building, in which at least partial direct vision is desired.

In contrast to the arrangement of flat element F depicted in FIG. 1b, in which the structured side S of the flat element facing the incident sunlight hν, FIG. 2 shows a situation in which the flat element F with its structured side S of the flat element faces away from the incident sunlight hν toward the interior of the building. In this case as well, the flat elements D between the adjacent structural elements SE contribute to the optical direct vision of the flat element F. The hatching indicates that in this situation, the structural elements SE can be designed in such a manner that no light is transmitted soley through the coparallel running defining surfaces, but rather impingement on the flanks of the structural elements SE and thus ensures an invented optical effect despite the direct vision region D.

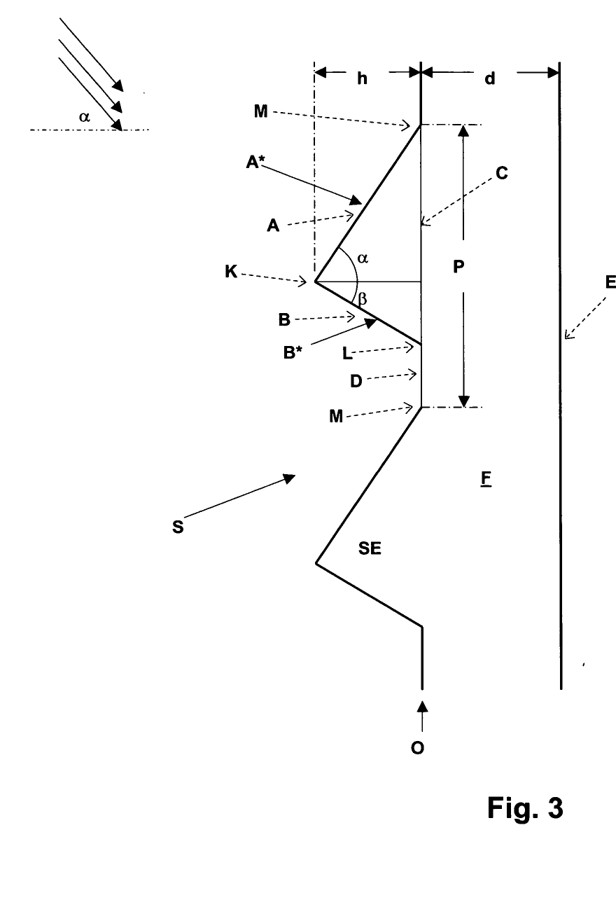

To aid in understanding the optical effect of the sun protection device according to the invented design, FIG. 3 shows a cross section thereof provided with corresponding reference values, respectively reference numbers. As mentioned in the preceding, the flat element F basically comprises a plane, unstructured flat element side E and a structured flat element side S. Structural elements SE, which have a triangular cross section, are provided in periodical succession on the sides of the structured flat element side S. Each of the individual structural elements SE is bordered by two lateral flanks A,B which protrude above a surface O of the flat element side S. Only for reasons of completeness, it is mentioned that each single structural element SE is virtually bordered by a lateral edge C, with the structural elements, of course, being joined and fabricated one-piece with the flat element F consisting of the transparent material. As, in their three-dimensional form, the structural elements SE represent prismatic triangular bodies, they are bordered corresponding to their cross section side flanks A,B by defining surfaces, respectively flank regions A* and B*. Moreover, the adjacent structural elements SE are laterally separated by flat element sections D, with flat element section D largely coinciding with the surface O. Preferably, the flat element sections D are designed plane and are oriented coparallel in relation to the flat element side E. In special preferred embodiments, the sections D, however, incline slightly relative to the flat element side E. Typical inclination angles lie, for example, between 0 and 10°.

Furthermore, it is assumed that the flat element F is preferably integrated vertically in a building façade aperture and is oriented facing south. In the same manner, it is feasible to orient the flat element F in oblique positions as well as in positions aligned between southeast to southwest. Depending on the orientation and the manner of installment of the sun protection device, the geometric embodiments and the inclination of the defining surface A* and B* should be suited thereto. Notably, this is decisively determined by the so-called sun profile angle α_{P}, corresponding to the angle between one flat normal relative to a vertical surface and the projection of the sun direction on that plane, which is tentered by the surface normals and a vertical straight line. Thus, for example, for a surface vertically aligned exactly in south direction, the sun profile angle αₚ assumes values between a minimum angle αₚᵤ and a maximum angle αₚₒ, always depending on the geographical latitude and the ecliptic in the following manner:
αpu=90 °−Φ−δₘₐₓ<αₚ<90°−Φ+δₘₐₓ=αₚₒ

In the above relationship Φ stands for the latitude and δₘₐₓ=23.45° for the maximum declination respectively maximum ecliptic yielded by the inclination of the axis of the earth in relation to the orbit of the sun.

In order to determine the design of the structural elements SE, the aforementioned conditions need to be taken into consideration if direct incident sunlight is largely to be prevented from entering the interior of the room.

If the flat element F is to be installed vertically and preferably aligned exactly in south direction, the following design criteria can be determined regarding the design of each single structural element: if, according to FIG. 3, it is assumed that the lateral flanks A and B form angles α and β in the manner shown in FIG. 3, in order to first mask out the light effectively with ever increasing angles of incidence when sunlight impinges directly on the respective defining surface A*, angles α and β must be selected in such a manner that a ray of sunlight entering through the defining surface A* of the structural element is refracted in such a manner that the latter is totally reflected on the rear flat element side E.

This case is given if the sunlight radiation assumes at least the smallest sun profile angle αₚᵤ₁, given by the following relationship:
αₚᵤ₁=90°−60 +arc sin[n sin(arc sin(1/n)−(90°−α))]

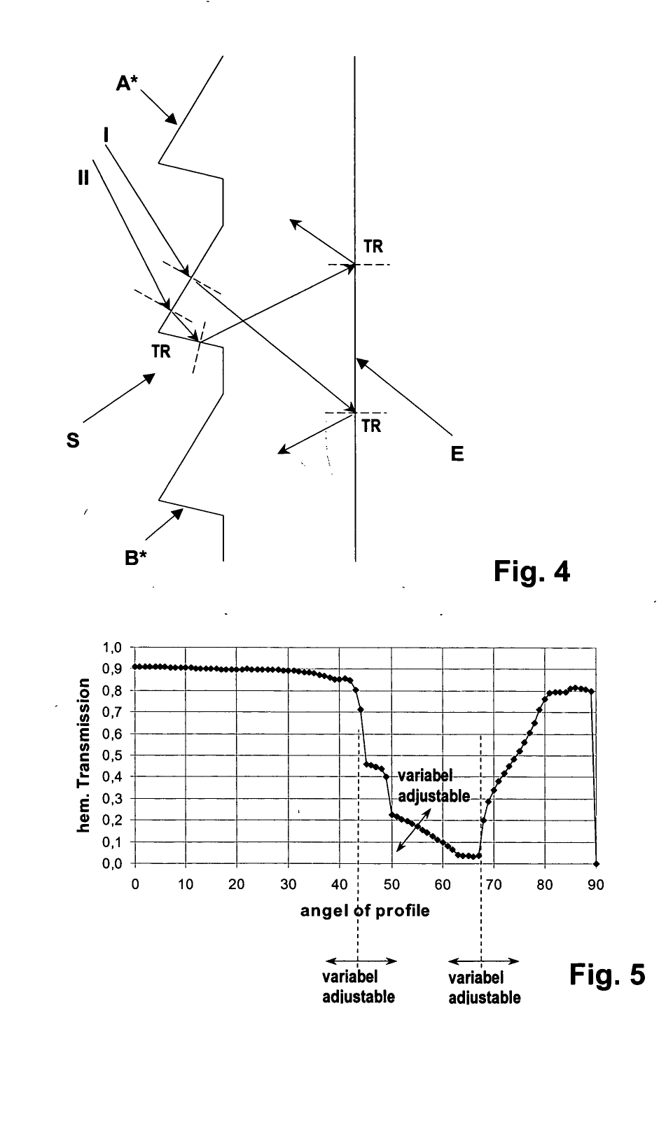

This case is depicted in FIG. 4 and described by the light path I. The light ray entering via the defining surface A* is refracted in such a manner at A* that the coupled-in ray of light is totally reflected at the unstructured, plane designed flat element side E and subsequently exits via the structured flat element side S.

Furthermore, the shading effect due to back reflection is intensified if, in addition, a ray of light entering the flat element F through the top defining surface A* is then totally reflected at the directly adjacent defining surface B* in such a manner that the ray of light finally impinges on the rear flat element side E at an angle at which the total reflection also occurs. Such a case is given if the sun radiation assumes at least a lower sun profile angle of the following form:
αₚᵤ₂=90°−α+arc sin[n sin(arc sin(1/n)+α+2β−0°)].

FIG. 4 depicts the preceding condition as well with reference to the beam path II. The light ray deflected twice by means of total reflection also exits flat element F via the structured flat element side S.

The upper limit of the masking out region is determined by a beam path which also enters the flat element F through the defining surface A* and impinges on the lower defining surface B* from the interior. However, if in contrast to the preceding case, total reflection no longer occurs at the defining surface B*, a considerable part of the sunlight radiation is transmitted through the flat element. The respective upper critical angle assumes the following form:
αₚₒ=90°−α+arc sin[n sin(arc sin(α+β−arc sin(1/n))].

With the aid of the preceding three critical angles, respectively equations, the masking region of the sun protection device designed according to the invention can be individually adapted to different lighting situations by selecting the angles α and β and selecting the defining surfaces A* and B*.

FIG. 5 shows a typical transmission diagram along the ordinates (semi-spatial respectively hemispherical) of which transmission values are provided and along the abscissas of which the sun profile angles are provided. Thus, it turns out that transmission distinctly diminishes in the angle region of approximately 42°. Further characteristic reduction occurs in the region of approximately 48°. It is not until in the region of approximately 68° that transmission of the flat element begins to characteristically increase so that the bright zenith light is transmitted again and contributes to daylight lighting.

Additional possible optimization is the selection of the structural height h of the single structural elements SE. If, for example, in the case of maximum partial direct vision, the flat element should mask out sunlight in the region between αₚᵤ₂ and αₚₒ, the minimum height h of the single structural elements SE is determined by the condition that self-shading still just occurs at the lower angle limit αₚᵤ₂ of the masking out region, thus the following formula is given:
h≈P/[tan(α)+tan(αₚᵤ₂)].

In this case, P stands for the period length of a structural element SE. This period length is yielded by the sum of the length of the lateral edge C and the clear span of the flat element D (see FIG. 3).

A similar relationship can also be determined for the lower sun profile angle αₚᵤ₁.

If the height h of the structural element SE is selected smaller, the direct vision region increases at the expense of the shading effect, respectively the masking effect. If the height h is selected higher, in some circumstances the masking effect improves further, but the direct vision diminishes accordingly.

The selection of a suited structure also depends (as the preceding equations indicate) on the refractive index of the material used. It is to be noted that the latitude in design/execution and the to-be-expected optical functionality and effect of the sun protection element is greater the greater the refractive index is. Usually, today materials with approximately 1.4<n<1.7 are available, with plastics with high refractive indices of n>1.55 being preferably suited for an invented sun protection element.

The preceding embodiments relate, as mentioned in the introduction, to a flat element whose structured flat element side S faces incident sunlight. If, however, the structured side of the flat element faces away from the light source, respectively from the incident sunlight, other critical angles are yielded, which however someone skilled in the art would derive on the bases of the preceding reflections.

With reference to the representation of FIG. 3, edge courses K, L, M, which are preferably designed straight, respectively sharp-edged, are provided between the single surface A*,B*, D if an optimum shading effect is to be obtained. Similarly, ideally it is assumed that the defining surfaces A*, B* and flat sections D are designed exactly plane.

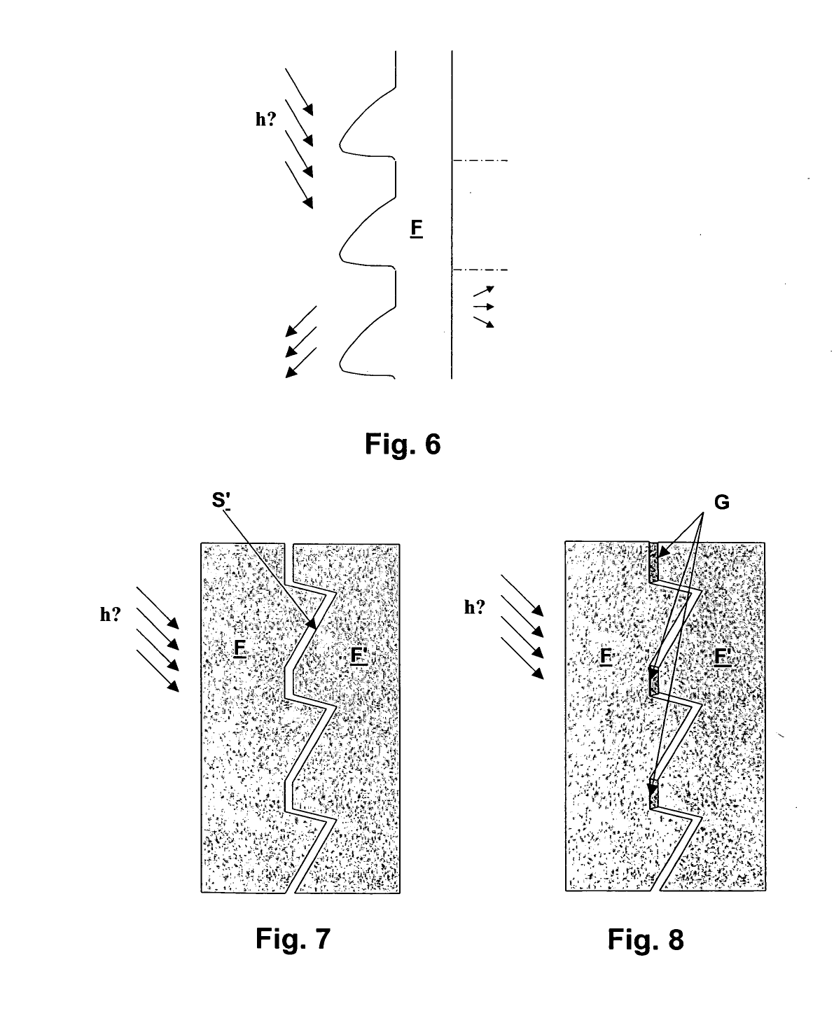

However, if it is desired that shading be only moderate and consequently room illumination with daylight greatly improved, the edges can be preferably rounded or one of the two oblique defining surfaces A* or B* can be curved or both can be curved. FIG. 6 shows such a type structure with curved defining surfaces and rounded edges. As can be expected, the desired optical masking out by means of such rounding is less effective, because light is deflected, respectively refracted, practically isotropically at the rounded edges K, L, M. This rounding can be designed as convex, concave or wavy surfaces by means of various production methods. The daylight effect of the sun protection device is primarily improved by means of such type measures. Thus, fundamentally incident sunlight is deflected on conic or curved areas. Although, in some cases, this light can lead to undesirable effects in the interior, with suited selection of such type structures, the light deflected at curved or conic designed surfaces leads to improved or more uniform illumination of the interior due to the diffuser effect inherent in such type flat element.

Light deflection at cones or curved surfaces generally leads to the occurrence of a glossy vertical band in the transmission, i.e. the horizontal component of the beam direction is not altered by the deflection at the rounding but definitely the vertical component is, resulting in the mentioned effect of a bright essentially vertical stripe.

This effect can be both weakened or completely prevented in that the single structural elements are also not exactly plane in the direction of their translation axis, but rather have a slight waviness, respectively slight curvatures, along their translation axis. In this manner, the light of the glossy band is distributed on a larger angle region and the, in some circumstances, disturbing glare effect is reduced. The waviness of the structural elements along the translation axis preferably has a stochastic character, because otherwise oblique glossy bands or other bright visible structures may form.

The optical functionality of the single structural elements SE can be further improved in comparison to the ones described in the preceding by providing one or a multiplicity of defining surfaces or partial areas of the structural elements SE with an optically effective layer. Such a type optically effective layer can develop, for example, a reflecting scattering or absorbing effect. In order to produce such types of effective layers, the structured flat element side S undergoes PVD (physical vapor deposition) coating, e.g. vapor deposition or sputtering) or CVD (chemical vapor deposition) coating. In an especially preferred manner, such a type coating process can be conducted by way of oblique masking in such a manner that surfaces of parts, respectively of partial areas, of the structural elements SE are treated selectively, thereby utilizing that the particles of the deposition processes move in a preferred direction in the gas phase (e.g. the vapor particles in vapor deposition, the scattered particles in sputtering) and thus form shadows, i.e. regions with lower a deposition rate compared to the adjacent regions, during coating of the structured surfaces.

In order to further improve the optical direct vision properties of the flat element F described in the preceding, in particular, in the case of providing a dielectric boundary along, for example, the defining surface B*, a preferred embodiment according to FIG. 7 provides a combination of a flat element F with a flat element F′ which is complementarily structured thereto. The flat element F′ is provided with a flat element side S′ which is complementarily structured to the structured flat element side S of flat element F. Joining of the two flat elements F′ and S′ preferably occurs in such a manner that joining of the two elements F and F′ occurs using a bonding agent layer G along the flat section D.

In the preferred embodiments shown in FIGS. 7 and 8, in addition to the direct vision region D, direct visions properties are obtained, particularly also in regions of the defining surfaces A* and B*, in viewing directions in which light is not totally reflected at the defining surface B* and/or E.

However, it must be noted that, in combinations with complementary flat element structures, the original flat element F is the first optically effective element in the light path and, therefore, the first optically effective element for the incident light. In this manner, the effect of such a type system generally differs very strongly from an isolated antiglare device as described in the preceding. The consequence is that a complementary flat element system F/F′, in which the complementary flat element F′ lies closest to the light source, requires a special structural design. If the structural elements of the original flat element F are provided on the side facing away from the light source, adding a complementary flat element does not influence the essential optical effect of the original flat element.

In a preferred embodiment, one or both of the joined flat elements can be fabricated of a transparent, flexible material, for example, a type of flexible foil or thin board. Suited rolling processes in which the complementary structures are interconnected can be employed to produce such type flexible complementary flat elements.

To economize on material, reduce absorption effects and facilitate integration of the sun protection device, for example, in an composite insulation glass, as well as to ultimately considerably reduce costs, it is especially advantageous to miniaturize the light-guiding prismatically designed structural elements. Such a microstructured flat element can, for example, be applied onto the glass pane as backing in the form of a microstructured foil. It is also feasible to directly structure the surface of a pane, for example of a window pane. A further advantage of micro-structures is, in particular, that the human eye can, in some circumstances, not resolve them, thus a quasi-homogeneous appearance is created.

This quasi-homogeneous appearance is, in particular, of advantage if the sun protection element is not to be utilized on a south oriented, but rather on an otherwise orientated area or façade. In this case, a desired sun protection function dependent on the sun profile angle can be ensured if the extended structural elements SE no longer are orientated horizontally, as is the case when oriented southward, but rather are tilted. If the sun protection element has a quasi-homogeneous appearance, this necessary tilting does not architectonically or aesthetically limit the possible use of the element.

Gray-tone lithography is especially suited to produce such type microstructures. This process usually is confined to areas small than 10 cm². However, prismatic structures can also be produced by means of material-removal processes or precision metal removing processing, for example, micro-milling or micro-blasting. Although large areas are processed with such a type process, the involved technical difficulties increase considerably for desired area sizes larger than 25 cm². However, even today interference lithographic processes offer the possibility of structuring large areas of up to 2500 cm² successfully in the desired homogeneous manner.

If a miniaturized structure in the form of a master structure is present, the latter can be applied to large areas by means of molding processes, thereby permitting replication of the microstructure. In this manner, surface structures can be transferred to or imprinted on various organic or inorganic materials, in molds or foils of any type or surface. Replication processes that should be mentioned in this context, are, for example, rolling imprinting processes, stamp imprinting processes and injection molding processes. With the preceding processes, it is, in particular, possible to produce the structured surface cost-effectively.

An especially preferred form of use of the invented sun protection device is integration in an insulation glass composite system. A flat element which is structured on the side facing the interior or a foil in general is applied onto the inner side of the outer pane (or in the case of triple glazing onto the inner side of the middle pane), whereas a flat element which is structured on the exterior is generally applied to the outer side of a pane which lies on the interior. Depending on the requirements, in individual cases, a third, fourth or a further layer, respectively pane, may be required in the insulation composite glass, respectively realized.

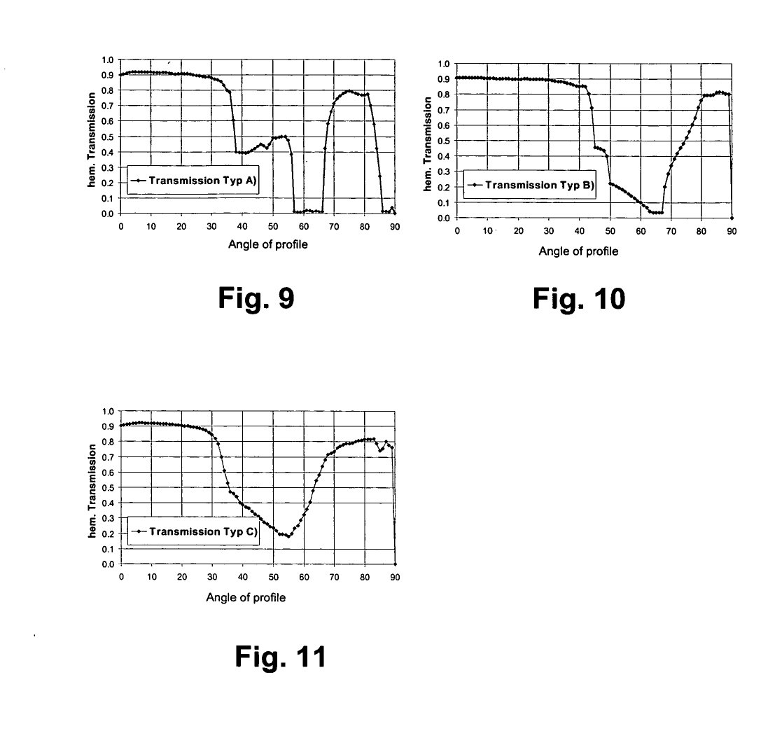

Finally FIGS. 9 to 11 show some transmission diagrams dependent on the lighting situation for the following concrete embodiments:

A vertically aligned sun protection device facing the light source and having the parameters α=48°, β=6°, h/P=0.5, n=1.59 (refractive index of the transparent material) possesses the property that only maximally up to 1.7% of the directed radiation, which enters solely from a profile angle range between 57° and 66°, is transmitted. In such a type structure, the direct vision part makes up approximately 39% of the overall area.

FIG. 9 shows the dependence of the total transmission on the incidence angle in radiation into the profile plane (profile angle) of such a type structure. It is distinctly clear that the marked masking out region in peak summer sun positions is up to approximately 67° and a moderate reduction of about 50% in a transition region. Simultaneously, the transmission of very high profile angles up to over 80° is very high, which has a positive effect on the illumination of the rearward space due to the bright skylight in the zenith region. Similarly, also for incidence angles smaller than approximately 35°.

This type of structure, therefore, is suited as seasonal sun protection for south façades in geographic latitudes in which the highest summer sun positions are smaller than 67°, e.g. the geographical latitude of Freiburg i. Br., Germany (φ=48°). Thus, in a period from May 2^{nd} to August 11^{th}, up to more than 98% of the directed direct sun radiation is reflected or absorbed by the element. In the transition periods for instance from March 12^{th} to May 1^{st} and August 12^{th} to September 30^{th}, only maximally 40-50% of the direct radiation is transmitted through the element. At the same time, high transmission and, therefore, solar energy contribution to room heating is ensured during winter. Good illumination with daylight is given at all times in a rearward space by means of the high transmission at high incidence angles.

The next example, shown in FIG. 10, relates to seasonal, i.e. temporary, sun protection with partial direct vision, with the structure being located on the side facing the light source and with an increasing profile angle, constantly increasing shading occurring in the shading periods.

FIG. 10 shows the transmission diagram of a sun protection device which possesses a vertically directed structure facing the light source and the parameters α=60°, β=1.5° and h/P=0.27 and has the property that directed radiation entering from a profile angle range between 43° and 67° increasingly weakens with an increasing incidence angle. In this ideal structure, the direct visions part makes up approximately 52% of the entire area. FIG. 10 clearly shows the shading setting in at 42° (equinox) steadily increasing up to the maximum sun position of approximately 67° and moderate reduction at about 50% in the transition region. At the same time, transmission for a very high angle profile from about 80° is very high, which has an positive effect on the illumination of the rearward space due to the bright sky light in the zenith region. The element also shows very high transmission for incidence angles smaller than 42°, permitting light and thermal input during the heating period and the transition seasons.

Finally FIG. 11 shows a transmission diagram of a sun protection device with rounded, respectively curved, running edges (K,L,M) and curved flanks (A*,B*), which can be utilized as a diffuser or a scatter pane with partial direct vision and a seasonal sun protection function to improve room illumination.

The flanks and edges are curved, respectively rounded, in such a manner that, unlike in the preceding cases in which a part of the incident radiation is precisely masked out, in each irradiation situation as well as in the incidence angle region in which principally a shading effect occurs, always one part of the incident light is scattered into the depth of the rearward space. The transmission level depends greatly on the type and extent of the curvatures and the waviness compared to a plane, sharp-edged structure.

Due to its specific masking angle region, the element on which FIG. 11 is based is suited, e.g. for use in northern Central Europe. Examples are: Berlin with φ=52.5° and maximum solar altitude angle 61°, Hamburg with φ=53.5° and maximum solar altitude angle 60° or Moscow with φ=56° and maximum solar altitude angle 57.5°. Alternatively, the element can be easily utilized in Central and Southern Europe in south façades inclined northward.

Reference Signs

F,F′ flat element
E unstructured plane flat element
S structured flat element side
SE structural element
O surface
A,B side flanks
A*, B* defining surfaces
D flat section
K,L,M edges
P period lengths

1. A sun protection device for transparent apertures in a building against direct incident sunlight entering the interior of the building, said device comprising:
at least one optical flat element comprising at least partially transparent material, being installable in a region of said transparent apertures, and having two flat element sides facing each other, of which one is non-structured and plane, and another one is provided with prismatic linearly extending structural elements running in parallel and recurring periodically in a lateral direction, whereby another side is provided, facing said one plane, flat element side, with an at least a substantially coparallel surface, over which said structural elements project, and said structural elements have a triangular cross section area having a lateral edge, which coincides with said substantially coplanar surface, as well as two lateral flanks protruding above the substantially coplanar surface, with one defining surface being assigned to one of said lateral flanks and another defining surface being assigned to another of said lateral flanks; and
at least two adjacent structural elements are laterally separated by a flat section of said substantially coplanar surface, and said one of said lateral flanks forms an angle 90°-α with said substantially coplanar surface, an angle α+β with said another of said lateral flanks and said another of lateral flanks forms an angle 90°-β with said surface, with it being given:
α≠β and
α≠0° and β≠0° and
said optical flat element is installed in said region of said transparent apertures in such a manner that said one flat element side faces said incident sunlight.

2. The device according to claim 1, wherein α is larger than β.

3. The device according to claim 1, wherein said one lateral flank is joined with said surface via an edge, said one lateral flank and said another lateral flank are joined via an edge and said another lateral flank is joined with said surface via an edge.

4. The device according to claim 1, wherein said flat element is integrated in a vertically extending building aperture and said two flat element sides are oriented vertically.

5. The device according to claim 4, wherein said one lateral flank is inclined toward said vertically directed surface in such a manner that the radiation transmitted through said device is reduced from a smallest sun profile angle αₚᵤ₁, which corresponds to an angle between area normals on said surface as well as projection of sun direction on a plane, which is entered from said area normals and a vertical straight line, in that rays entering through said one defining surface and subsequently impinging on said one flat element side are totally reflected, with the following relationship being given:
αₚᵤ₁=90°−α+arc sin[n sin(arc sin(1/n)−(90°−α))]
with n: the refractive index of said transparent material.

6. The device according to claim 5, wherein said lateral flanks are inclined toward said vertically directed surface in such a manner that the radiation transmitted through said device is reduced from a smallest sun profile angle α pu2, which corresponds to an angle between the area normals on said surface as well as the projection of sun direction on a plane, which is spanned from said area normals and vertical straight line, in that rays entering through said one defining surface and then impinging on said another defining surface are totally reflected and subsequently impinge on said one flat element side and are again totally reflected there, with the following relationship being given:
αₚᵤ₂=90°−α+arc sin[n sin(arc sin(1/n)+α+2β−90°)]
with n: the refractive index of said transparent material.

7. The device according to claim 5 or 6, wherein said lateral flanks are inclined toward said vertically directed surface in such a manner that the radiation transmitted through said device is reduced up to a largest sun profile angle αₚₒ, which corresponds to an angle between the area normals on said surface as well as the projection of the sun direction on a plane, which is spanned from said area normals and a vertical straight line, in that rays entering through said one defining surface and subsequently impinging on said another defining surface are substantially totally reflected and subsequently impinge on said one flat element side and are again totally reflected, with the following relationship being given:
αₚₒ=90°−α+arc sin[n sin(arc sin(α+β−arc sin(1/n))]
with n: the refractive index of said transparent material.

8. The device according to one of the claims 5 to 7, wherein said lateral flanks have a common point of intersection which provides a distance h from said surface, for which is given:
h≈P/[tan(α)+tan(αₚᵤ₁)]
or
h≈P/[tan(α)+tan(αₚᵤ₂)]
with P:=the period length of a structural element, respectively of a recurring unit
=the length of said lateral edge+the clear span of said flat section.

9. The device according to claim 3, wherein said edges are at least partially sharp edges or are rounded at least partially concave or convex.

10. The device according to claim 9, wherein said edges have at least partially a stochastic or periodic surface waviness.

11. The device according to claim 1, wherein said lateral flanks, said one defining surface and/or said another defining surface, said flat section and/or said one flat element side are designed at least partially as optically effective areas at which light is reflected, scattered or absorbed.

12. The device according to claim 1, wherein said defining surfaces are designed plane or as at least partially convex, concave, convex-wavy or concave-wavy curved areas.

13. The device according to one of the claims 1-6 and 9-12, wherein said flat section is one of a designed plane and at least partially curved area, and
said flat section is one of oriented coparallel to said one flat element side and disposed inclined thereto at an angle of between 0° and approximately 10°.

14. The device according to claim 1, wherein said another flat element side of a first flat element is joined to a complementary structured flat element side of a second flat element.

15. The device according to claim 14, wherein said joining of said two flat elements occurs by means of a bonding agent at those areas which correspond to said flat section of the first said flat element.

16. The device according to claim 1, wherein said one optical flat element is fabricated from a flexible material, which is mountable on a flat transparent carrier structure in a foil-like manner.

17. The device according to claim 1, wherein said one optical flat element is designed as a window pane.

18. The device according to claim 1, wherein said one optical flat element is designed as part of a multiple pane insulation glazing.

19. The device according to claim 1, wherein said one optical flat element is integrable in a building aperture which is slanted in relation to the verticals.

20. A method of producing a device according to claim 11, wherein said optically functional areas are produced a PVD process or a CVD process.

21. The method according to claim 20, wherein the surface of at least parts of said another flat element side is treated by means of vapor deposition with a preferred movement direction of the vapor particles by way of self-shading.

22. A use of the sun protection device according to one of the claims 1-6 and 9-19 as a one of a light deflecting device and an antiglare device.

23. The device according to claim 7, wherein said flat section is one of a designed plane and an at least partially curved area, and said flat section is one of oriented coparallel to said one flat element side and disposed inclined thereto at an angle of between 0° and approximately 10°.

24. The device according to claim 8, wherein said flat section is one of a designed plane and an at least partially curved area, and said flat section is one of oriented coparallel to said one flat element side and disposed inclined thereto at an angle of between 0° and approximately 10°.
